(19) United States
(12) Patent Application Publication
(10) Pub. No.: US 2005/0153661 A1
(43) Pub. Date: Jul. 14, 2005

(54) Toy radio telephones

(76) Inventor: Stephen C. Beck, Berkeley, CA (US)

Correspondence Address: Law Offices of Seldon & Scillieri, 10940 Whilshire Boulevard, Eighteenth Floor, Los Angeles, CA, 90024, US

(21) Appl. No.: 10/754,645

(22) Filed: Jan. 9, 2004

(51) Int. Cl. H04B 1/38

(52) U.S. Cl. 455/73

(57) ABSTRACT

In one embodiment, toy radio phones enable children to speak and listen at the same time. Another embodiment provides for sending and storing messages directly into the memory of a receiving toy radio phone for later retrieval. Yet another embodiment provides for storing recorded messages into the memory of a calling toy radio phone for later sending to a receiving radio phone.

This application claims priority of two U.S. Provisional Patent Applications, Ser. Nos. 60/305,034 and 60/305,029, filed Jul. 12, 2001 and Jul. 12, 2001, now abandoned, which in their entirety are incorporated by reference herein, and PCT Patent Application Serial No. PCT/US02/22,299 filed Jul. 12, 2002, which in its entirety is incorporated by reference herein.

### FIELD OF THE INVENTION

This invention relates generally to toys and, more particularly, to toy radio telephones.

### BACKGROUND

Radio communication devices, including toys, are available today. Examples of such devices include walkie-talkies and TALKABOUT® communication devices from Motorola. TALKABOUT® devices generally operate and look like walkie-talkies. Unlike telephones, walkie-talkies and TALKABOUT® devices operate on a half-duplex mode. This means that users only talk or listen at one time, i.e. they cannot talk and listen at the same time. Users generally press a push-to-talk button to speak and release that button to listen. Voice-operated switches (VOX) are often use as well.

Unlike telephones, walkie-talkie type devices are not assigned or identified with their own identity code, such as a phone number. Furthermore, a calling child cannot indicate with whom in particular they want to communicate, except by being on the same operating frequency and subchannel. Generally, no indication that you are the intended recipient is provided by such walkie-talkie type devices, unlike conventional phones that provide ringing sounds or flashing indications. A child user of such walkie-talkie type devices also cannot leave messages similarly to how users of cell phones leave messages.

TALKABOUT® devices, in addition to a push-to-talk button, generally also include a small numeric visual display indicating the channel and subchannel numbers being used. They also include a loudspeaker for listening and an internal microphone for talking. They are usually styled as hand-held devices.

TALKABOUT® devices operate in the Family Radio Service (FRS) bands allocated and governed by the Federal Communications Commission (FCC). These FRS bands are license-free. There are fourteen operating frequencies, ranging from 462.5625 to 467.7125 MHz. On each of these frequencies, there can be an additional thirty-eight subchannels, for a total of five hundred thirty two operating numbers (fourteen×thirty-eight=five hundred thirty-two).

Similar to walkie-talkies and TALKABOUT® devices, cellular (or cell) phones also use radio waves to transmit audio information. Cell phones, however, do not use the FRS bands and they operate in full duplex. Furthermore, cell phones basically operate using a transceiver-repeater-antenna radio frequency (RF) system and operate in a cell framework. Cell phone users also pay subscription or monthly fees to use cellular services.

Each cell-phone has its own unique phone number, which is typically assigned when a user signs up with a subscription plan. Users, however, cannot reprogram their cellular phones with a new phone number unless they change or obtain a new subscription plan. They also cannot assign any phone number to their cell phone unit.

Unlike walkie-talkie type of devices, users of cellular phones may leave messages for other parties when those parties are unavailable to pick up incoming calls. A connection, however, has to be made with a voice-mail system before a message can be recorded by the calling user. To retrieve these messages, a receiving user calls a phone number, punches in his or her password, and goes through that voice-mail system. These messages are stored external to cell phones.

Cell phones, including their subscription plans, are not cheap. A way for children or young adults to have toy radio devices that may communicate like cellular phones but yet are affordable in price, particularly without the monthly payment, is highly desirable. Thus important aspects of the technology used in the field of the invention remain amenable to useful refinement.

### SUMMARY OF THE DISCLOSURE

The present invention introduces such refinement. In its preferred embodiments, the present invention has several aspects or facets that can be used independently, although they are preferably employed together to optimize their benefits.

In preferred embodiments of a first of its facets or aspects, the invention is a method of receiving a radio message by a receiving toy radio phone. This receiving toy radio phone is programmed with one or more identity phone numbers, which identify that toy radio phone. The message contains audio and/or textual data.

The method includes the step of receiving a direct point-to-point encoded radio calling signal containing at least one toy radio phone number or a portion thereof. Each toy radio phone number or portion thereof, contained in the calling signal, indicates an intended receiving toy radio phone or phones. Another step is decoding the received calling signal to determine the intended toy radio phone or phones. Yet another step is determining if the receiving toy radio phone is one of the intended toy radio phones.

The foregoing may represent a description or definition of the first aspect or facet of the invention in its broadest or most general form. Even as couched in these broad terms, however, it can be seen that this facet of the invention importantly advances the art.

In particular, this facet of the invention provides a key feature that enables children to communicate with each other in such a manner that they can indicate with whom in particular they want to communicate. This is generally done by merely remembering and punching in phone numbers. Furthermore, this facet enables this manner of communication without paying any subscription fees like cellular phones. This facet also provides the capability of making party line calls and programming user-defined phone numbers. This facet thus solves the problem of indicating with whom a child wants to speak with, the problem of paying subscription fees, and other problems discussed in the earlier section of this document. In addition, this facet provides using the family radio service (FRS) bands or the non-FRS bands. Full-duplex mode and half-duplex mode of communication may also be provided.

Although the first major aspect of the invention thus significantly advances the art, nevertheless to optimize enjoyment of its benefits preferably the invention is practiced in conjunction with certain additional features or characteristics as discussed in following sections of this document. For example, an additional step of receiving the radio message by the receiving toy radio phone may be added. Yet another step, for example, storing the received radio message into the memory of the receiving radio phone, may be further added. A step of enabling a user to speak and listen and the same time may also be incorporated.

In preferred embodiments of its second major independent facet or aspect, the invention is a method of storing and later sending an audio and/or textual message by a calling toy radio phone. This method includes the step of providing the message to the calling toy radio phone. Another step is storing the message into a memory of the calling toy radio phone. Yet another step is providing to the calling toy radio phone one or more phone numbers or a portion thereof that identifies an intended receiving toy radio phone or phones. Still another step is sending the message to the intended receiving toy radio phone or phones.

The foregoing may represent a description or definition of the second aspect or facet of the invention in its broadest or most general form. Even as couched in these broad terms, however, it can be seen that this facet of the invention importantly advances the art.

In particular, this facet of the invention provides children the ability to record messages even when the toy phone or phones that they are calling are busy, out of range, or are not answered. Such messages are generally later transmitted, thereby enabling children, at their convenience, to record messages for intended recipients without worrying if they have made the desired connection and while thoughts are still clear in their minds. This facet thus solves the issue of being able to leave messages using walkie-talkie type devices and even the issue of needing to make a connection even before a message can be left that exists in other devices. This facet thus solves some of the problems discussed in the earlier “Background” section of this document.

Although the second major aspect of the invention thus significantly advances the art, nevertheless to optimize enjoyment of its benefits preferably the invention is practiced in conjunction with certain additional features or characteristics as discussed in following sections of this document. For example, the step of storing the received message into the memory of the intended receiving toy radio phone may be added. This enables these parties to retrieve their messages at their convenience.

The next major aspect, although an independent facet or aspect, is a different manifestation of the common principles embodied also in the first aspect. Consequently, the next aspect also has the same benefits and advantages as discussed in the earlier first facet.

In preferred embodiments of its third major independent facet or aspect, the invention is a device for use with a toy radio phone. This device includes a processor, an operating program, and a memory storing the operating program. The operating program controls and instructs the processor to cause the toy radio phone to perform a number of operations. One operation is to receive a direct point-to-point encoded radio calling signal containing at least one toy radio phone number or a portion thereof. Each toy radio phone number or a portion thereof, contained in the calling signal, indicates an intended receiving toy radio phone or phones. Another operation is to decode the received calling signal to determine the intended toy radio phone or phones. Yet another operation is to determine whether the toy radio phone is one of the intended toy radio phones.

The foregoing may represent a description or definition of the third aspect or facet of the invention in its broadest or most general form. Even as couched in these broad terms, however, it can be seen that this facet of the invention importantly advances the art.

In particular, this facet provides devices—such as chips, microcontrollers, or printed circuit boards with chips—that are easily manufactured and thus may drive down the cost. Economy of scale may also lower the cost. Although the third major aspect of the invention thus significantly advances the art, nevertheless to optimize enjoyment of its benefits preferably the invention is practiced in conjunction with certain additional features or characteristics as discussed in following sections of this document.

The next major aspect, although an independent facet or aspect, is a different manifestation of the common principles embodied also in the second aspect. Consequently, the next aspect also has the same benefits and advantages as discussed in the earlier second facet of the invention. Furthermore, because this aspect is in the form of devices, e.g. microcontrollers or chips, the benefits discussed in the third facet, thus also apply.

In preferred embodiments of its fourth major independent facet or aspect, the invention is a device for use with a toy radio phone. This device includes a processor, an operating program, and a memory storing the operating program. The operating program controls and instructs the processor to cause the toy radio phone to perform a number of operations. One operation is to provide a message to the toy radio phone. Another operation is to store the message into a memory of the toy radio phone. Yet another operation is to provide to the toy radio phone one or more phone numbers or a portion thereof identifying an intended receiving toy radio phone or phones. Still another operation is to send the message to the intended receiving toy radio phone or phones.

The foregoing may represent a description or definition of the fourth aspect or facet of the invention in its broadest or most general form. Even as couched in these broad terms, however, it can be seen that this facet of the invention importantly advances the art.

In particular, this device provides substantially the same benefits and advantages of the second and third facets discussed above. Although the fourth major aspect of the invention thus significantly advances the art, nevertheless to optimize enjoyment of its benefits preferably the invention is practiced in conjunction with certain additional features or characteristics as discussed in following sections of this document.

The next major aspect, although an independent facet or aspect, is a different manifestation of the common principles embodied also in the first aspect. Consequently, the next aspect also has the same benefits and advantages as discussed in the earlier first facet.

In preferred embodiments of its fifth major independent facet or aspect, the invention is a toy radio phone device. This device includes an antenna, a radio frequency receiver circuit, a radio frequency transmitter circuit, a microcontroller, and a housing. The radio frequency receiver circuit interfaces with the antenna. The radio frequency transmitter circuit also interfaces with the antenna. The housing houses the antenna, the receiver circuit, the transmitter circuit, and the microcontroller.

The microcontroller includes a processor, a read-only memory, and an operating program stored in the read-only-memory to perform a method. This method includes the step of receiving a direct point-to-point encoded radio calling signal containing at least one toy radio phone number or a portion thereof. Each toy radio phone number or a portion thereof, contained in the calling signal, indicates an intended receiving toy radio phone or phones. Another step is decoding the received calling signal to determine the intended toy radio phone or phones. Yet another step is determining if the receiving toy radio phone is one of the intended toy radio phones.

The foregoing may represent a description or definition of the fifth aspect or facet of the invention in its broadest or most general form. Even as couched in these broad terms, however, it can be seen that this facet of the invention importantly advances the art.

In particular, this facet provides for toy radio phone devices that are finished products and may be made available for sale. Although the fifth major aspect of the invention thus significantly advances the art, nevertheless to optimize enjoyment of its benefits preferably the invention is practiced in conjunction with certain additional features or characteristics discussed in following sections of this document.

The next major aspect, although an independent facet or aspect, is a different manifestation of the common principles embodied also in the second aspect. Consequently, the next aspect also has the same benefits and advantages as discussed in the earlier second facet of the invention. Furthermore, because this aspect is in the form of toy radio phone devices, the benefits in the fifth facet thereby also apply.

In preferred embodiments of its sixth major independent facet or aspect, the invention is a toy radio phone device. This device includes an antenna, a radio frequency receiver circuit, a radio frequency transmitter circuit, a microcontroller, and a housing. The radio frequency receiver circuit interfaces with the antenna. The radio frequency transmitter circuit also interfaces with the antenna. The housing houses the antenna, the receiver circuit, the transmitter circuit, and the microcontroller.

The microcontroller includes a processor, a read-only memory, and an operating program stored in the read-only-memory to perform a method. The method includes the step of providing an audio and/or textual message to the calling toy radio phone. Another step is storing such message into a memory of the calling toy radio phone. Yet another step is providing to the calling toy radio phone one or more phone numbers or a portion thereof identifying an intended receiving toy radio phone or phones. Still another step is sending the message to the intended receiving toy radio phone or phones.

The foregoing may represent a description or definition of the sixth aspect or facet of the invention in its broadest or most general form. Even as couched in these broad terms, however, it can be seen that this facet of the invention importantly advances the art.

In particular, this facet provides substantially the same benefits and advantages of the second and fifth facets discussed above. This facet is generally provided by toy manufacturers, distributors, and retailers by providing such toy radio phone devices to children for their use. Although the sixth major aspect of the invention thus significantly advances the art, nevertheless to optimize enjoyment of its benefits preferably the invention is practiced in conjunction with certain additional features or characteristics discussed in following sections of this document.

In preferred embodiments of its seventh major independent facet or aspect, the invention is a method of communicating between a calling radio phone and a receiving radio phone. The method includes the step of providing to the calling toy radio phone one or more phone numbers or a portion thereof identifying the receiving toy radio phone. It also includes providing an audio and/or textual message to the calling toy radio phone. Another step is storing the message into a memory of the calling toy radio phone. Yet another step is receiving a direct point-to-point radio calling signal by the receiving toy radio phone from the calling toy radio phone. The calling signal contains at least one toy radio phone number or a portion thereof that identify the receiving toy radio phone. Yet another step is sending by said receiving toy radio phone one or more signals to the calling toy radio phone. A still further step is sending, by the calling toy radio phone, the message to the receiving toy radio phone.

The foregoing may represent a description or definition of the seventh aspect or facet of the invention in its broadest or most general form. Even as couched in these broad terms, however, it can be seen that this facet of the invention importantly advances the art.

In particular, this facet provides the ability for a child caller and child receiver to communicate with each other by recording messages. This communication does not need to be in real time and thus may be time delayed. Furthermore, this facet also addresses the issues discussed in the first facet of the invention. Consequently, the benefits of the first facet also apply here. Although the seventh major aspect of the invention thus significantly advances the art, nevertheless to optimize enjoyment of its benefits preferably the invention is practiced in conjunction with certain additional features or characteristics as discussed in following sections of this document.

All of the foregoing operational principles and advantages of the present invention will be more fully appreciated upon consideration of the following detailed description, with reference to the appended drawing, of which:

### BRIEF DESCRIPTION OF THE DRAWINGS

FIG. 1 is a perspective view of a toy radio telephone, constructed in accordance with a preferred embodiment of the invention;

FIG. 2 is a like view of FIG. 1, but showing internal components;

FIG. 3 is a high-level block diagram of a microcontroller, constructed in accordance with a preferred embodiment of the invention;

FIG. 4 is a high-level flowchart of exemplary operations for communicating with a FIG. 1 toy radio phone, in accordance with a preferred embodiment of the invention;

FIGS. 5A and 5B are high-level flowcharts of exemplary operations for transmitting a textual or audio message or communication to a FIG. 1 toy radio phone, in accordance with preferred embodiments of the invention;

FIG. 6 is an exemplary high-level electronics block diagram of a FIG. 1 toy radio phone visual display;

FIG. 7 is an exemplary high-level electronics block diagram of a FIG. 1 toy radio phone input and output components;

FIG. 8 is an exemplary high-level electronics block diagram of a FIG. 1 toy radio phone transmitting and receiving components;

FIG. 9A is a perspective view of an alternate embodiment of a toy radio phone, but with a cover, constructed in accordance with an embodiment of the invention;

FIG. 9B is a like view of FIG. 9A, but with the cover closed;

FIG. 9C is a back view of FIG. 9A;

FIG. 10A is a perspective view of an alternate embodiment of a toy radio phone that is circular in shape, in accordance with an embodiment of the invention;

FIG. 10B is a like view of FIG. 10A, but showing an earbud;

FIG. 10C is a diagram of how a FIG. 10A toy radio phone may be oriented;

FIG. 10D is a back view of FIG. 10A;

FIG. 11A is a perspective view of an alternate embodiment of a toy radio phone, with a bottom cover, in accordance with an embodiment of the invention;

FIG. 11B is a side view of the FIG. 11A toy radio phone;

FIGS. 12 and 13 are perspective views of alternate embodiments of a toy radio phone, without covers, in accordance with embodiments of the invention;

FIG. 14A is another perspective view of an alternate embodiment of a toy radio phone, with a cover, in accordance with an embodiment of the invention;

FIG. 14B is a like view of FIG. 14A, but with the cover closed;

FIG. 15A is a perspective view of an alternate embodiment of a toy radio phone, with a top cover, in accordance with an embodiment of the invention;

FIG. 15B is a side view of the FIG. 15A toy radio phone;

FIG. 16A is a perspective view of an alternate embodiment of a toy radio phone that flips open like a wallet, in accordance with an embodiment of the invention;

FIG. 16B is a side view of the FIG. 16A toy radio phone;

FIG. 16C is an exemplary illustration of how the FIG. 16A toy radio phone may be worn;

FIG. 17A is another perspective view of an alternate embodiment of a toy radio phone, without a cover, in accordance with an embodiment of the invention;

FIG. 17B is a side view of the FIG. 17A toy radio phone;

FIG. 18A is another perspective view of an alternate embodiment of a toy radio phone that flips open like a wallet, in accordance with an embodiment of the invention;

FIG. 18B is a side view of the FIG. 18A toy radio phone;

FIG. 19A is another perspective view of an alternate embodiment of a toy radio phone without a cover, in accordance with an embodiment of the invention;

FIG. 19B is a side view of the FIG. 19A toy radio phone;

FIG. 19C is an exemplary illustration of how the FIG. 19A toy radio phone may be held;

FIG. 20A is another perspective view of an alternate embodiment of a toy radio phone with a top cover, in accordance with an embodiment of the invention;

FIG. 20B is a side view of the FIG. 20A toy radio phone;

FIG. 21A is another perspective view of an alternate embodiment of a toy radio phone but with replaceable covers, in accordance with an embodiment of the invention; and

FIG. 21B is a like view of FIG. 21A toy radio phone, but with the covers open.

### DETAILED DESCRIPTION OF PREFERRED EMBODIMENTS

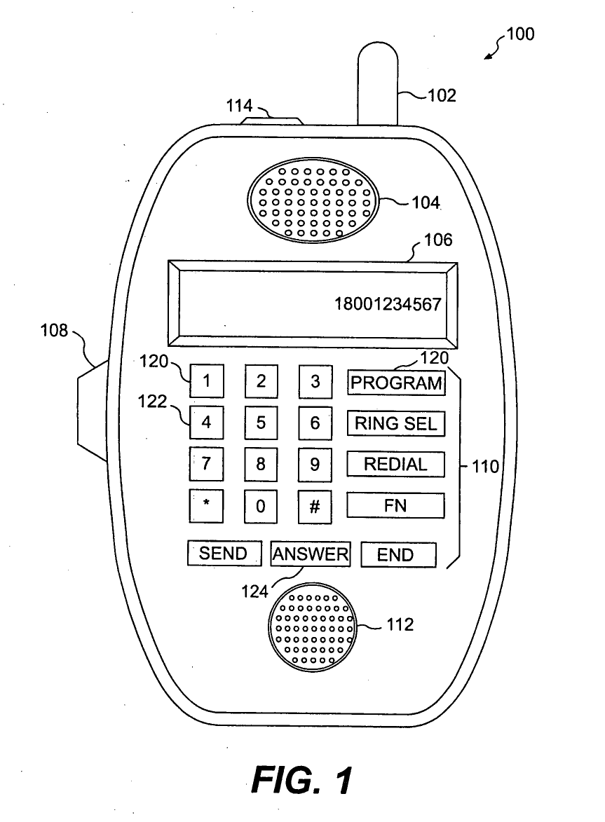

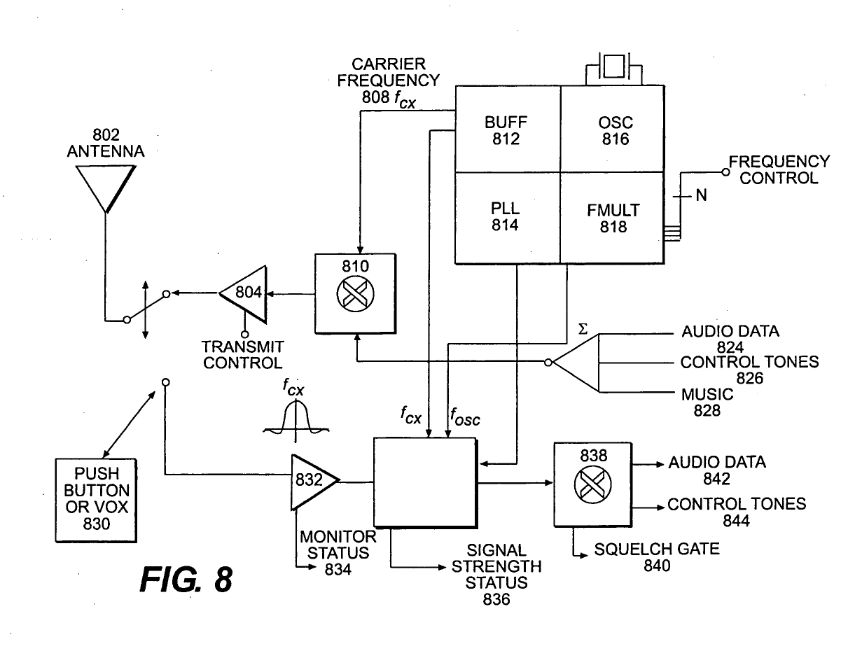

A toy radio phone 100 (FIG. 1) of one preferred embodiment preferably has much of the look, feel, and functionality of a cellular telephone. It is preferably primarily designed to be a toy or a youth electronic communication device. The toy radio phone 100 communicates with identical or similar devices and is preferably enclosed in a design and styling package resembling cellular phones (FIGS. 9 through 21). The toy radio phone also communicates in several modes, i.e. one-to-one, one-to-many, or many-to-many (similar to party lines and audio voice chat rooms), by way of special control buttons or feature functions, e.g. “Party Line” or “Chat Room” button.

The toy radio phone 100 (FIG. 1) communicates with identical or similar devices in a direct point-to-point path of radio frequency (RF) signals. In the preferred embodiment, the toy radio phone 100 operates in license-free frequency bands, i.e. the Family Radio Service (FRS) bands. The toy radio phone 100 may operate in fourteen frequencies, with each frequency capable of handling thirty-eight subchannels, totaling to five-hundred thirty-two operating channels. Allowing for one of the fourteen frequencies to be the monitoring frequency, at least thirteen separate communications may occur at the same time within a given operating range for a radio frequency (RF) signal.

The toy radio phone 100 communicates various information, including, for example, voice, music, control tones, and digital data, over a reasonable distance ranging from five hundred feet up to roughly two miles or more. This way, a toy radio phone 100 may be considered a “toy” cellular phone, which are used by kids within their local neighborhood, school area, or similar zone of operation.

In the United States, the FRS frequency bands have been declared to be usable by any radio communication devices that conform to the rules and regulations of the Federal Communications Commission (FCC). Certain restrictions on audio signals apply in certain license-free RF bands.

The toy radio phone 100 may also operate outside the FRS bands, such as in the very high frequency (VHF), ultrahigh frequency (UHF), and super high frequency (SHF) ranges. The operating frequencies may range in value from forty-nine (49) megahertz (MHz) to 5 gigahertz (GHz) or more. Information to be transmitted by such toy radio phones 100 may be modulated by analog or digital methods.

The toy radio phone 100 preferably includes an on/off button 108, an audio input device, an audio output device, a screen display 106, an antenna 102, and a touch-tone keypad 110. The touch-tone keypad 110 is preferably similar to those seen in regular phones, e.g. cellular and wireless phones, but with additional buttons to support functions or features provided by the toy radio phone 100. The child user generally speaks through an input piece 112 and receives audio output through an output piece 104. The screen 106 may be used to show or display various information, including the phone number dialed, connection status, operating status information, signal strength, the phone number of the toy radio phone 100, etc.

The touch-tone keypad 110 preferably contains a number of push buttons representing digits zero through nine (“0” through “9”), an asterisk (“*”), and an octothorpe/pound key (“#”). The touch-tone keypad may also contain other buttons and sliders, including for example, a program selector (“Program”) 120, a ring selector (“Ring Sel”), a redial button (“Redial”), a function selector (“Fn”), a send button (“Send”), an answer button 124 (“Answer”), and an end button (“End”). These additional buttons generally represent control function features or programmable features available on the toy radio phone 100.

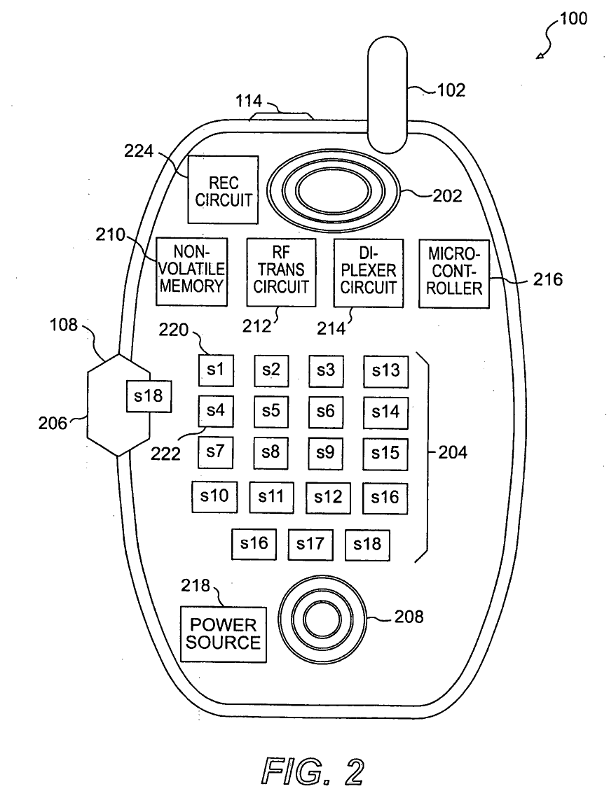

Each button in the keypad 110 is associated with a respective switch 204 (FIG. 2). For example, the buttons representing the digits one (“1”) 120 and four (“4”) 122 (FIG. 1) are each associated with switch s1 220 and switch s4 222, respectively (FIG. 2). The on/off button 108 is also associated with a respective switch s18 206. Each switch 204 is activated when a child user presses or releases the associated button 110 (FIG. 1).

An audio output device 202 (FIG. 2), for example, a loud speaker, an earphone, or any other sound-producing device or acoustic transducer device, is typically underneath the output piece 104 (FIG. 1). From this audio output device 202 (FIG. 2), audio outputs, such as music transmitted to the toy radio phone, voices of other parties, party messages, ringing sounds, and alert beeps, may be heard. External output devices may also be connected to the toy radio phone 100 by providing an external jack or plug slot 114 to receive these devices. Such external devices include, but are not limited to, headphones, headsets, earphones, and earbuds (ear pieces shaped to fit in the ears of a user, similar to hearing-aid devices). An external speaker, for example, may be used with the toy radio phone 100 if the plug of such speaker is inserted into the jack 114.

An audio input device 208 (FIG. 2), preferably a microphone, is generally underneath the input piece 112 (FIG. 1) to receive a child's input, such as speech. Similar to output devices, external input devices (e.g. headsets, microphones, etc.) may be connected to the toy radio phone by plugging such external devices into the plug 114. Devices that generate output that may be used as input to the toy radio phone 100 may also be connected—for example, a CD player or an MP3 player. If a CD player is plugged into the toy radio phone 100, for example through another jack, the receiving party who receives the call hears the song being played on that CD player.

It is possible that a toy radio phone 100 does not have an internal input device 208 and/or output device 202 (FIG. 2). In this scenario, external audio devices may just be plugged into the toy radio phone via one or more jacks 114 to receive input and to produce output. Infrared output and input devices may also be used if infrared interface or interfaces are incorporated in the toy radio phone 100.

A radio frequency receiver circuit (receiver) 224 and antenna 102 (FIG. 2) are also included to receive RF signals, such as audio voice, tone signals, and data signals, from any transmitting source in the frequency range of operation. These signals are typically received from other similar toy radio phone 100 devices.

The antenna 102 is preferably built-in. This antenna 102 may be one-eight (⅛), one-fourth (¼), or one-half (½) wavelength tuned to the center frequency of operation in the RF band of operation.

The toy radio phone 100 also includes an RF transmitter circuit 212, interfacing with an antenna 102, to send output information (communication for transmission) to other identical or similar toy radio phones 100. The output information may be sent to more than one party (or child0, i.e. to two or more similar or identical toy radio phones. The same antenna 102 may be used for RF signal reception and transmission. Unlike cellular phones, the toy radio phone is not a true cellular telephone in that it communicates with identical or similar devices in a direct point-to-point path of the RF signal, rather than via a common transceiver/repeater/antenna RF system of cellular phone networks.

A duplexer circuit 214, interfacing with the antenna 102, transmitter circuit 212, and the receiver circuit 224, is also included to separate, isolate, and control the radio transmitter 212 and receiver 224, so as to support both half-duplex and full-duplex operations, on the same or split frequencies. The duplexer 214 also preferably includes an RF switch to connect the antenna 102 to either the receiver circuit input 224 or transmitter circuit output 212, with minimal energy loss.

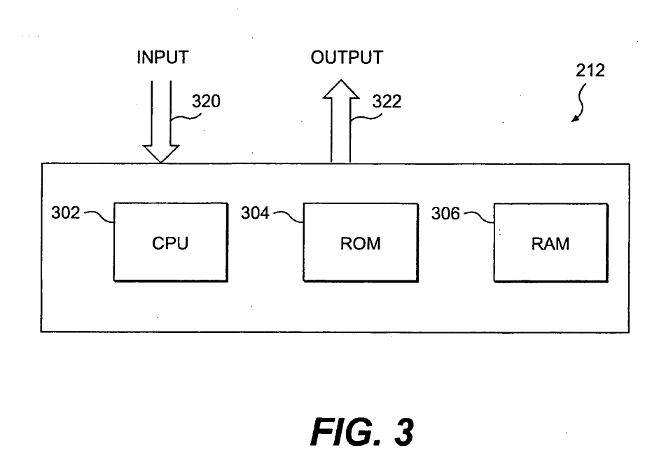

A microcontroller 216, generally comprising a processor (CPU) 302 (FIG. 3), a read-only memory (ROM) 304, and a random-access memory (RAM) 306, is also included. An operating program controlling the operations of the CPU and the various components and features of the toy radio phone 100 is stored into a memory, preferably in ROM 304. Operating information, e.g. variable information, may be stored in another memory, preferably RAM 306. Such memory may be implemented using one or memory devices. One or more interfaces to receive input signals 320 and send output signals 322 are also available. The operating program contains operating instructions executed by the CPU 302, which control, for example, the ringing of the phone, the transmission and reception of information, the storing of voice mail into memory, and other various operations of the toy radio phone 100.

A memory device 210 (FIG. 2), internal or external to the microprocessor 216, is preferably included to store certain information, such as voice-messages, text messages, and the like. It may be a semiconductor memory device and preferably nonvolatile read/write memory—e.g. flash memory. This information may be transmitted and heard via the audio output device 202, seen through the visual display 106 (FIG. 1), or seen or heard through an externally plugged output device (using the jack 114). This memory device may also be an external memory card.

A power source 218 (FIG. 2) to supply suitable and sufficient power is also needed. Such power source, e.g. AA batteries, is preferably placed at the back of the toy radio phone 100. It may be a set of batteries or an external power source connected to the toy radio phone unit by means of a power cable. It may be from house main line power via power-supply adapters or vehicle power such as from twelve VDC adapters commonly found in cars, boats, trains, etc. This power supply operates by means of a transformer and rectifier/filter circuit, with regulation, to convert from a line power (one hundred ten (110)/two hundred twenty (220) VAC 50/60 Hz) to the low-voltage DC power (from three to twelve VDC) sufficient to operate the components, such as circuitries, in this toy radio phone 100. A hand-cranked generator or dynamo for charging the power source 208, e.g. batteries may also be incorporated in the phone unit.

In one embodiment, visual display indicators in the form of various colored light-emitting diodes (LEDs) or other miniature light sources are part of the toy radio phone 100. These visual indicators may provide status information, such as whether the toy radio phone is in a receiving or transmitting mode.

One or more visual displays or screens 106 (FIG. 1) may also be added, e.g. liquid crystal display (LCD)-type screens, LEDs, and color or monochrome screens. The screen 106 may be used to display various information, including, for example, the number being called, the phone number of the incoming caller—“caller ID”, a text message received, and other operational information. This screen 106 may also display symbolic icons to indicate status of operation, battery-power level, connection status, signal strength, etc.

A voice scrambler or hasher may also be included. This scrambler generally tries to render the transmitted audio output unintelligible to unauthorized or unintended parties who may be listening to the frequency of transmission. Intended receivers, however, may decode and listen to the transmitted scrambled output by using a complementary descrambler, e.g. using a password code.

The toy radio phone 100 also includes analog and/or digital methods of modulating, demodulating, receiving, and transmitting information between one or more toy radio phones on the RF band of operation. Various modulation methods to encode output information in the transmitted radio frequency carrier, include, but are not limited to, amplitude modulation (AM), frequency modulation (FM), phase modulation (PM), single sideband, double sideband, suppressed carrier modulation (SSB/DSB/SC), pulse position modulation (PPM), pulse width modulation (PWM), frequency shift keying (FSK), and dual-tone multifrequency (DTMF).

A receiver “squelch” circuit that blocks, on the part of the receiving toy radio phone unit, the reception of transmitted audio and voice signals may also be included in the toy radio phone 100. To enable reception of the transmitted information, the sending child party also transmits certain specific control signals, preferably with the transmitted audio and voice signals. This prevents unauthorized parties from interfering with existing communications or sending unwanted communications, e.g. to ensure the reception of information or communication only from a certain group of toy radio phones. A voice-activated electronic (VOX) switch to automatically control the mode (e.g. transmission or reception) of each phone unit 100 is also preferably incorporated in the toy radio phone.

In the preferred embodiment, a calling number is each assigned to or programmed into a radio-phone unit. This phone number, unique or not unique, may be factory- or user-programmed and is preferably stored in a non-volatile read/write memory. In another embodiment, the toy radio phone may be programmed or assigned with more than one phone number. In another embodiment, this programmed phone number may be changed at any time and may be changed to any desired number. This feature may be implemented by using one of the buttons or feature options of the toy radio phone; for example, a child selects the “Program” button 120 (FIG. 1), selects the “phone number” program option, and enters a desired phone number. The toy radio phone number may mimic regular phones numbers, i.e. have an area code and a seven-digit number. Alternatively, the phone number may be of any length and may even include other symbols, such as the asterisk or the pound key as part of the phone number.

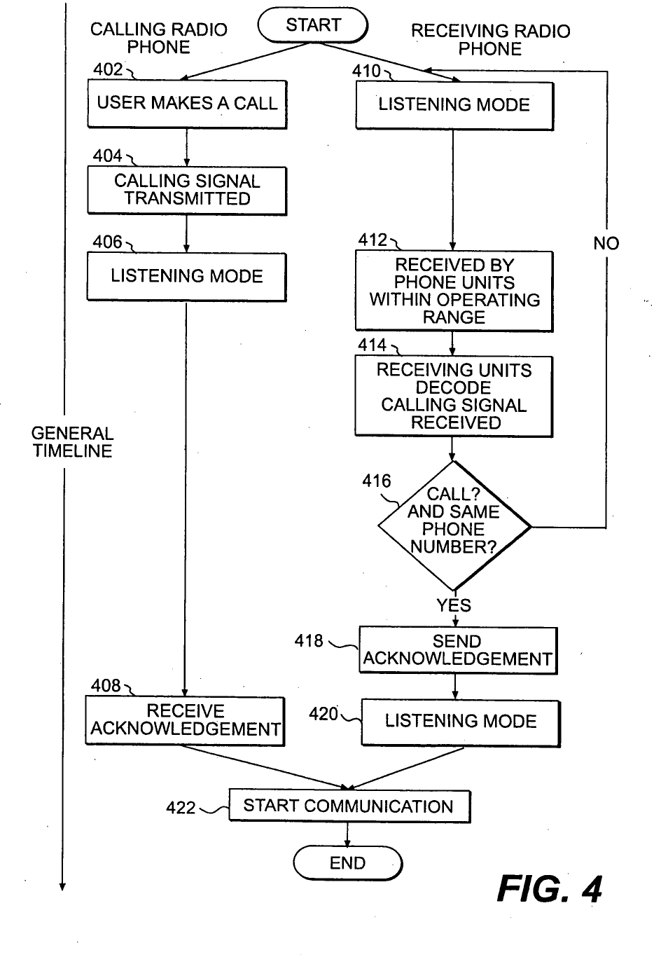

To enable a call between two or more radio-phone units 100, each toy radio phone is set to a standby ready-to-receive or listening mode 410 (FIG. 4) when not actively used to make a call. Generally, the various toy radio phones monitor, on a time multiplexed basis, a particular frequency or a set of frequencies to check whether a calling signal is being transmitted in the monitored frequency or frequencies. The format of the calling signal may be designed in various ways. In one embodiment, a calling signal may be identified as such if the first portion of the transmitted communication contains a “1, i.e. indicating a call. A “2”” (two) in the first portion of the transmitted communication may, for example, indicate an acknowledgement that a certain phone call has been received, while a “3” may indicate that a call has been picked up and answered.

A child wishing to make a call to another party, depending on the toy radio phone design, flips open his or her toy radio phone and dials the intended recipient's toy radio phone number—e.g. presses the phone number sequence (toy radio phone number) and then presses the “Send” button 402. This operation is similar to making a call using cellular telephones. The calling user, however, may dial a number of phone numbers using the “PARTY LINE” option in the toy radio phone.

In one embodiment, a child initiates a party-line call by just pressing a portion of the desired phone number. For example, a child needs to only press in sequence “7,” “2,” “8,” and the “Send” button to automatically dial and have a party-line call with all toy radio phones with phone number starting with ”728.”

Generally, once the “Send” button is pressed, the calling toy radio phone changes to one of the calling monitor frequencies, and transmits a brief duration calling signal 404. A child using one of the program options or function buttons generally sets the monitored frequencies. A set of manufacturer's default values may also be initially stored.

The calling signal is typically encoded into the RF transmission by any number of means. One example is by using dual-tone multifrequency (DTMF) tone codes to accomplish the signaling and transmission of the called number. The calling toy radio phone unit may also transmit its own identity number, which is preferably the calling unit's phone number, encoded with the calling signal. The calling signal is also encoded with the phone numbers of the intended receiving toy radio phones. The duration of the calling signal is preferably brief—one to fifteen seconds or less. The duration period may also be predetermined in the operating instructions stored in ROM, or may be alternatively, changed by the user. The transmission of the calling signal is repeated periodically until a call is deemed received or not, or after a certain criterion (e.g. time elapsed, number of tries, and call finally answered) has been met. After transmission, the calling toy radio phone reverts to the listening mode 406 while waiting for an acknowledgement signal. The calling unit may also periodically transmit the calling signal on a timed basis, every N seconds, until a set of certain criteria has been reached.

Generally, all toy radio phone units within the range of operation (usually within two miles), which are in the listening mode, receive the transmitted signal 410, 412. The receiving toy radio phones decode the signal to determine wheter it is a calling signal. They also decode the signal to determine the phone number dialed by the calling toy radio phone unit. Error detection codes may also be transmitted with the calling signal, so that receiving units may verify correct reception.

If a receiving unit within the range of the calling unit successfully decodes a calling signal, determines that it is an incoming call, and determines that the number dialed is the same number matching the identity (e.g. phone number or portion thereof) of that unit, then that receiving unit activates its ringing sound and changes to the receiving/listening mode. The ringing sound of the receiving unit depends on the selected ringing sound programmed to that unit. It may be a default sound or one programmed by the child. It may be a voice—e.g. “incoming call,” music—e.g. first few notes of a song, or a sound effect—e.g. sound of a door chime. The ringing sound may be selected from several preprogrammed ringing sounds and/or may be composed from a ringing sound sequence generated from an externally-attached keyboard or keypad. The ringing sound is generally an electronically synthesized sound.

A visual indicator on the calling unit may optionally flash a light or the screen may display a symbolic icon to indicate reception of calling signal. The receiving unit may also optionally display or audibly speak the phone number (“caller ID”) of the calling unit, so that the identity of the caller is revealed to the receiving toy radio phone units before the receiving users answer the incoming call.

If a child of the called unit now responds to the ringing signal, he or she may “answer” the call by various means. One example is by flipping open the cover of the unit, which then activates a switch contact that is polled by the microcontroller 216 (FIG. 2) to recognize the “answer” of the call. Another way is by pressing an ANSWER button 124 (FIG. 1).

If a child decides to answer a call 416 (FIG. 4), an acknowledgement signal 418 is transmitted. The calling phone receives this acknowledgement signal, if within the operating range 408.

When the receiving phone unit answers the call, a brief audible tone signal is also preferably generated to inform the calling child user that the caller and the receiving child user may now start a conversation or communication. At around this point, too, the answering unit transmits an acknowledgement signal 418 (CALL RECEIVE ACKNOWLEDGED) indicating that the call is answered. This informs the calling unit that the desired toy radio phone or phones have been reached by the caller. There may also be at this time, an additional “hand-shaking” protocol or signals between the two units. This hand-shaking may be repeated one or more times until successfully acknowledgement is sent and received by both units. The duration of the signaling is preferably brief Once answered, the child users may talk as long as they want until they “hang” up or they are out of the operating range.

At this point, the two parties can commence communication 422. If operating in the half-duplex mode, one party can press the SEND or TALK button on their unit, while the other party listens. This half-duplex mode generally operates in the FRS frequency bands. In a full-duplex mode, the parties communicate with each other, similar to how people communicate using regular phones, i.e. both may speak and listen at the same time.

Additionally, upon a successful call answer, both units may then change to a different operating frequency and subchannel, thus moving the monitoring frequency to a different private frequency. This may be manually done by selecting an appropriate button or automatically done by both calling and receiving toy radio phones.

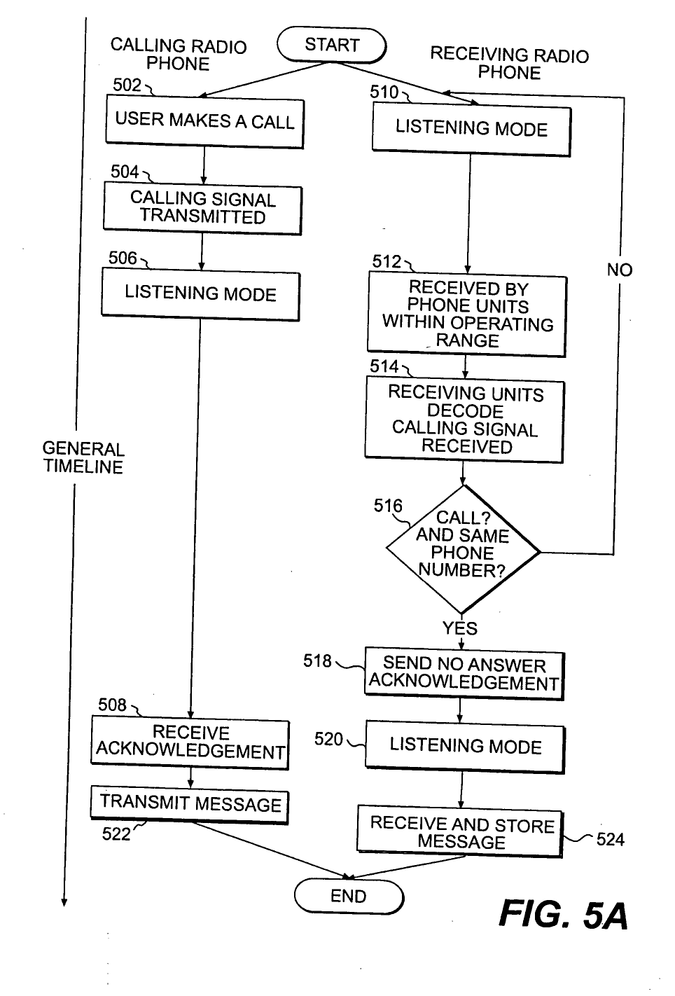

If the calling unit never receives a CALL RECEIVE ACKNOWLEDGE signal or any type of acknowledgement, it, after a certain number of tries or a given time interval (perhaps ten to twenty seconds)—i.e. based on a certain criterion or set of criteria, stops transmitting the attempted call. It is possible that a receiving toy radio phone unit is on but the child user is not able or available to take a call (FIG. 5A). In this scenario, the receiving toy radio phone within the operating range also receives and decodes the transmitted calling signal 512, 514. If the receiving unit matches the phone number dialed by the calling unit and a certain criterion or set of criteria has been met (e.g. certain number of time has elapsed or ringing has occurred), an acknowledgement indicating that the CALL is RECEIVED BUT NOT ANSWERED (no answer acknowledgement) is sent 518. This indicates that the receiving unit is on but the call is not answered. The calling unit receives this acknowledgement 508.

In one embodiment, during the time the acknowledgement is received by the calling unit, an audible beep or signal indicating that the calling child may now leave a message, text or audio, is heard by the calling unit. The child may then enter a textual message using the touch-tone keypad or speak the message into an input device. This textual message may include ASCII characters, special characters, icons, and the like. This message is then transmitted 522 in the operating frequency by the calling phone, received by the receiving unit, and stored into memory 524, preferably a nonvolatile memory, for later retrieval by the child of the receiving toy radio phone. In this embodiment, the message is stored in the phone of the receiving toy radio phone. Certain hand-shaking may be done between the sending and receiving units to ensure successful transmission and storage of the message.

It is also possible that the intended receiving phone is not ON or is out of the operating frequency range. In this scenario, an acknowledgement may not even be received at all by the calling unit. In this scenario, the calling child user still records a message or set of messages. The calling phone attempts to make the call so as to transmit the recorded message, similar to the operations discussed above.

In another embodiment, the message is initially recorded and stored in the memory of the calling toy radio phone unit (FIG. 5B). In this embodiment, the operations are similar to those discussed above. The receiving phone unit or units are unavailable and one or more no-answer acknowledgements 508 (or no acknowledgement) are received by the calling toy radio phone. This means that the intended receiving phone is not picking up, not on, or outside the operating range. The calling child is then prompted by the toy radio phone to record a message or set of messages (textual or audio). This message or messages are stored in the memory of the calling phone unit 521. This message is then periodically sent by the calling unit (or sent based on a certain criterion or set of criteria) to the intended receiving phone units that sent a no-answer acknowledgement or sent no acknowledgement at all. In one embodiment, the calling phone unit calls each of those no-answer acknowledgement or no acknowledgement receiving phones until each call is finally answered or certain set of criteria are met. This means when the receiving child user finally answers the call, such receiving child, instead of talking with the calling child, hears (e.g. through a speaker) or sees (e.g. through a visual display) the recorded message. In another embodiment, if the retried calls are never answered, the message is then transmitted and recorded in the memory of the receiving phone units, at least if the receiving phones are at least on.

In another embodiment, the operations are varied in some ways. In this case, the child first records a message or a set of messages that is saved into memory. In the next operation, the calling child identifies the intended recipients of this message or set of messages by keying in the appropriate phone numbers or portions thereof. The child may do so by hitting the “Program” button and selecting an appropriate option. The calling toy radio phone then calls each of the identified recipients or toy radio phones. The calling toy radio phone then transmits the message when the call is answered (call receive acknowledged) by the receiving phone unit or stores the transmitted message in the nonvolatile memory of the receiving toy radio phone.

The operating program contained in the ROM 304 (FIG. 3) may contain instructions such that when a new message is received, visual or audible indicators are set to indicate that a message is waiting to be retrieved. The toy radio phone may also include message-maintenance features, such as providing a child the ability to delete, resave, edit, etc. messages. In one embodiment, the receiving phone may receive and store a message even if the child is in the middle of answering a different call.

If the call is never answered, the calling toy radio phone units may also be programmed to do a number of alternative things, such as try placing the call again after a predetermined and selectable time delay (thirty seconds, one minute, etc.), record a message to be sent at a later time, and the like.

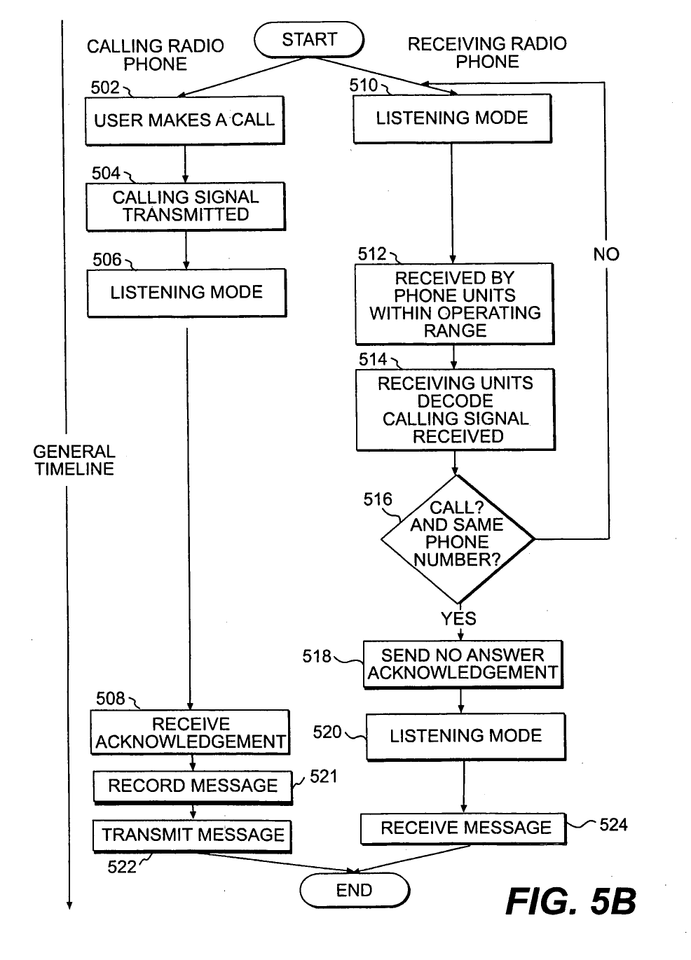

A visual display 602 (FIG. 6) included in a toy radio phone is generally controlled by display controls 604 and a microprocessor 606. The microprocessor executes the instructions generally stored in a ROM 608. The RAM 610 contains volatile information or data needed in controlling the visual display. The RAM 610 may also contain other information used for other components or features of the toy radio phone. Information stored in nonvolatile memory 622 may also be used to control the visual display 602. Information stored in nonvolatile memory may include recorded messages. Such messages may be displayed and be used to control the visual display to show a message-received icon.

Inputs are received from the switch matrix keypad 614. Control data 618 and monitor status data 520 are accordingly processed and also available to be used by other various components of the toy radio phone, for example, to synchronize producing a beeping sound when a connecting status icon is shown on the display, or for controlling other features of the toy radio phone. A crystal oscillator 616 preferably interfaces with the microprocessor 606.

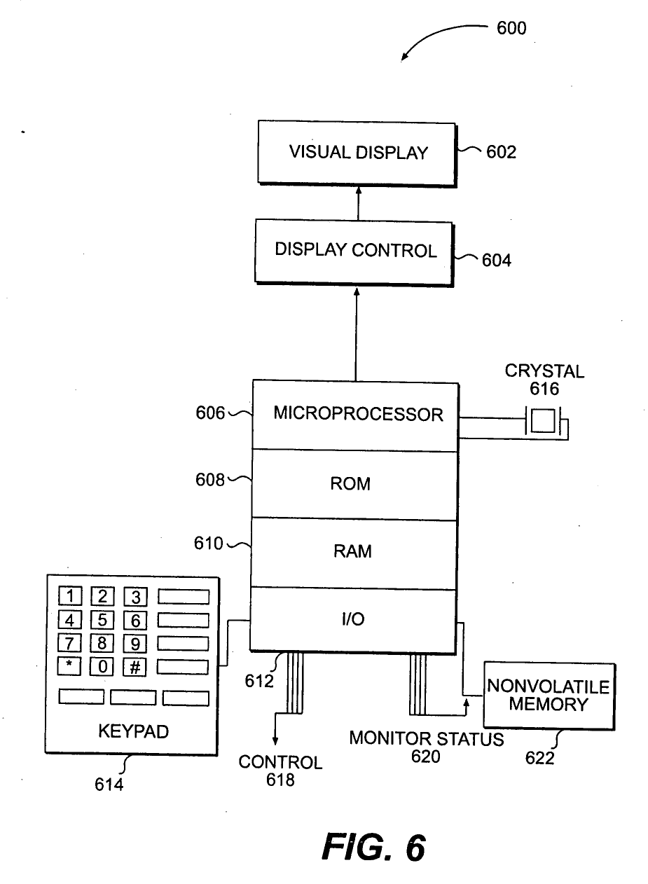

A child's speech 702 (FIG. 7) is preferably received by a microphone 704 and amplified by an amplifier 706. An external audio device may also be used if plugged into a jack 708 that receives such type of devices, e.g. jack for an external microphone. Sound effects 712, music through CD players, MP3, and keyboards (e.g. MIDI keyboards) 718 may also be received as input. Control data 714, 720 related to the sound effects, and music, CD, MP3, and keyboard 718 are also made available for use by the toy radio phone or be sent by the microcontroller 216 (FIG. 2) to control what audio information are to be used.

In one embodiment, DTMF is used. DTMF is generally a type of audio signals generated when buttons on a touch-tone telephone are pressed. If DTMF is used, a DTMF tone generator 724 is included. If other types of audio signals are used, appropriate tone generators 730 are also accordingly included. Appropriate control data 726, 732 are sent by the microcontroller or also made available for other components of the toy radio phone to use.

Depending on switch settings, data transfer may occur through the audio bus 740. If appropriate switches 710, 716, 722, 728, 734, 752, 760, 764 are set, audio output data may be amplified by an amplifier 754 and outputted through a speaker 756 to produce sound 770. Audio output data may also be heard through an external device, e.g. a headset or a headphone, if such device is plugged into a jack 758. Depending on switch settings, a child may also access appropriate recorded messages, sounds, etc. via a voice/sound record and playback integrated circuit (IC) 762. This may be done by having a child press the program button 120 (FIG. 1) and selecting a message playback option. This IC 762 (FIG. 7) also makes available control 766 and status 768 information. The microcontroller may also sent control data or status information to this IC. During the audio input process and audio output process, appropriate analog-to-digital and/or digital-to-analog conversions are done.

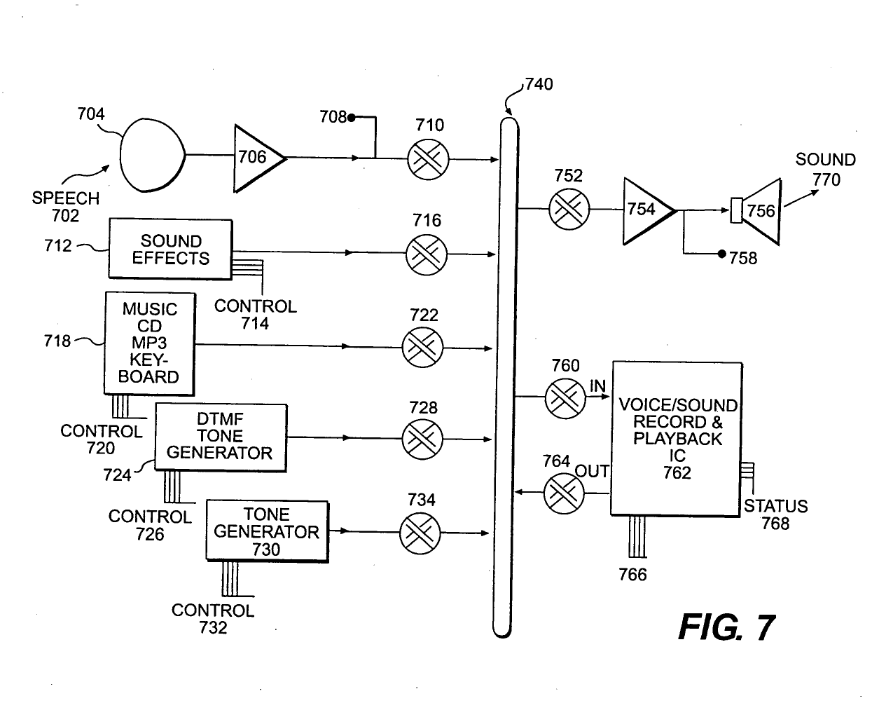

An antenna 802 (FIG. 8), preferably built-in to the toy radio phone 100 (FIG. 1), in conjunction with an RF transmitter circuit 212 (FIG. 2) and a receiver circuit 224, acts as a transmitter and receiver of radio waves. An external antenna may also be connected by way of cable and plug into the toy radio phone. This external antenna may be used to extend the operating range of the toy radio phones, such as by placing an external antenna on the roof of a home, connected to the toy radio phone by coaxial cables.

A toy radio phone 100 generally has a number of components. Depending on what information is being transmitted to another toy radio phone, certain signals , e.g. calling signals or acknowledgement signals, are generated. Signals may contain certain information such as audio and data 824 (FIG. 8) (e.g. speech), control tones 826, and music 828. This information to be transmitted is modulated (modulated signals) with the carrier frequency by a modulator 810, amplified by an RF power amplifier 804, and transmitted via the antenna 802. A crystal oscillator 816, a buffer 812, a phase-locked-loop 814, and a frequency multiplexer 818 are also part of the electronics of a toy radio phone, particularly the RF transmitter circuit. The frequency multiplexer 818 controls the carrier frequency. A duplexer to enable full-duplex mode may also be integrated within the circuit. This generally depends on the operating frequencies used by the toy radio phone, e.g. if FRS frequencies are used, the toy radio phone operates in the half-duplex mode.

The mode of operation, e.g. transmission or reception, may be manually activated by pressing a push-to-talk button when in the half-duplex mode. Alternatively, the modes may be controlled automatically by a voice-activated switch 830.

The antenna 802, in conjunction with a receiver circuit, 224 (FIG. 2) receives incoming signals. These signals pass through an RF amplifier and filter 832 (FIG. 8). A voice-activated switch 830 rather than a push-to-talk button preferably triggers reception processing. Signal strength 836 and monitor status i834 data are also made available to the other components of the toy radio phone or sent by the microcontroller. The signal strength status indicates whether the other party is moving out of the operational range. Monitor status indicates the status or the condition of incoming signals, e.g. transmission mode. Incoming signals are decoded and processed by a demodulator 838 to receive the textual or audio data 842, including control tones 844. The incoming signals may also be used to control the operation of the toy radio phone, such as block an incoming call, automatically activate the voice-messaging system, and the like. A squelch gate 840 to give more privacy, i.e. to prevent unauthorized parties or children to interfere with your communication may also interface with the demodulator.

In one embodiment, games may also be incorporated into the toy radio phone using some features of the invention. For example, a fox hunt-type or follow-the-leader type of game may be incorporated in the operating program stored in ROM 304 (FIG. 3). This type of game, for example, uses signal strength information. The signal strength is visually shown on a screen, and a user may have to locate another child user based on the signal strength displayed.

In one embodiment, a toy radio phone 900 (FIGS. 9A through 9C) has a button antenna 904 (FIGS. 9B and 9C) that may be pulled out when the toy radio phone is flipped open (FIG. 9A). The face cover 910 flips open when a release button 906 is pushed. A keypad 902 and a display 908 are also present. A battery case 912 to hold AA-type batteries is at the back, along with a belt clip 914.

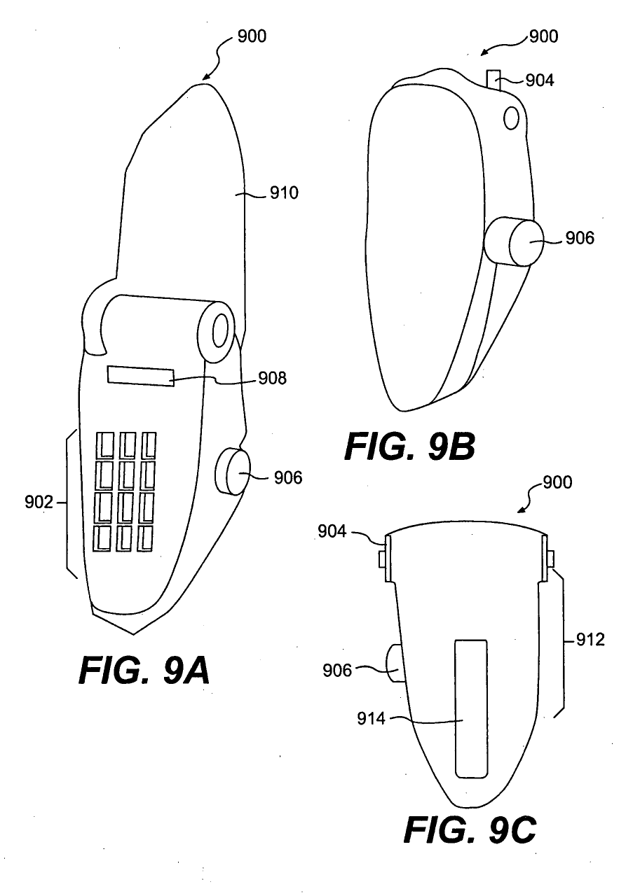

In another embodiment, a toy radio phone 1000 (FIGS. 10A through 10D) has a fixed antenna 1016, a visual display 1004, and a keypad 1002. The toy radio phone 1000 is turned on or off by pushing an on/off button 1012. It is designed to be hooked or placed on a belt with the earbud or headset cord hidden under the shirt. This way the toy radio phone 1000 may be made inconspicuous. An earbud 1006 is plugged into a jack or slot 1008 so that the user may hear audio output. Belt hook attachments 1010 and a battery case 1014 are generally at the back of the toy radio phone 1000 (FIG. 10D). The toy radio phone unit 1000 is also designed to be worn in many ways (e.g. up or down) (FIG. 10C) to facilitate ease of dialing using the keypad 1002 (FIG. 10C).

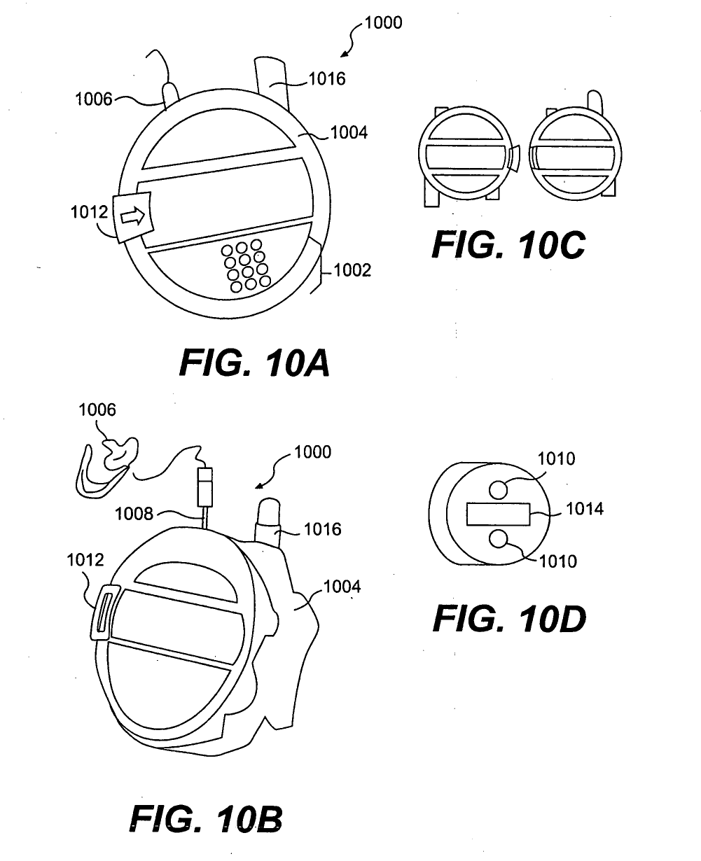

In another embodiment, a toy radio phone 1100 (FIGS. 11A and 11B) has a ring 1102 for attachment to a neck chain or a belt hook. A bottom cover 1104 may be flipped open to reveal a keypad 1106. The toy radio phone 1100 may also be designed such that flipping the bottom cover closed, automatically turns off the toy radio phone unit immediately after or after a certain amount of time. An on/off push button 1108 turns the unit 1100 on or off. A jack 1110 is available to accept external input and/or output audio devices.

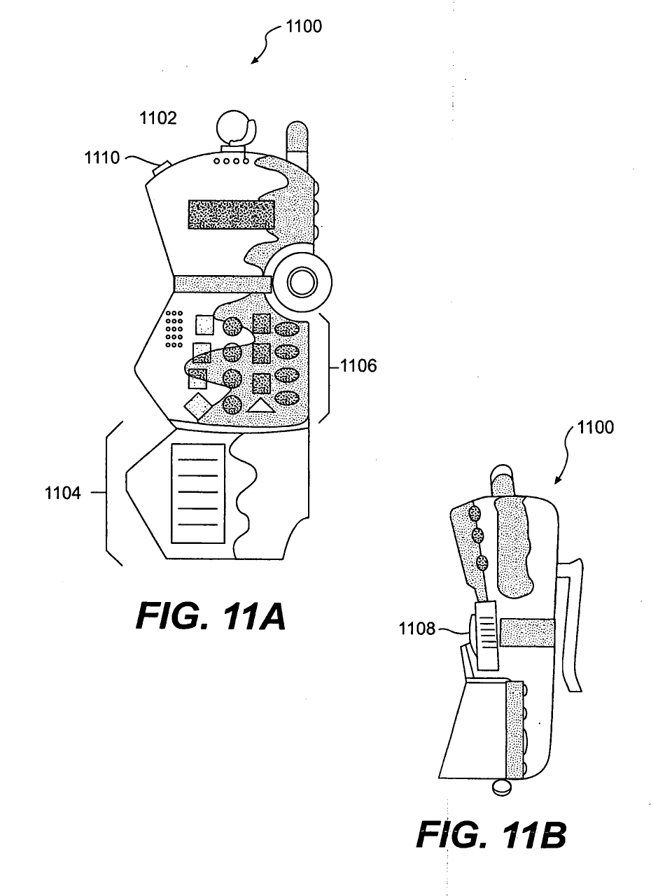

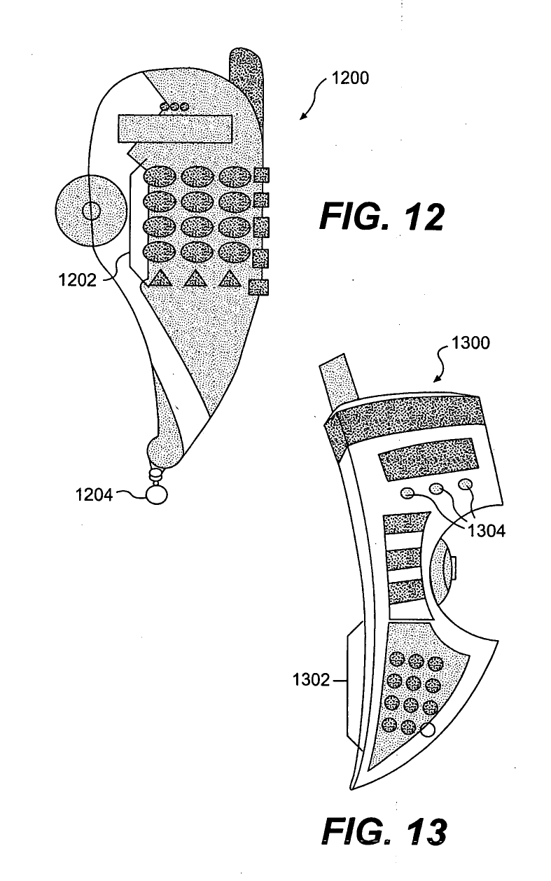

In another embodiment, the keypads 1202, 1302 (FIGS. 12 and 13) of the toy radio phones 1200, 1300 are directly accessible, similar to some cellular phones available today. In one embodiment, the toy radio phone 1200 also has a ring 1204 for neck or belt hook attachment. A number of LEDs 1304 (FIG. 13) may also be used as status indicators.

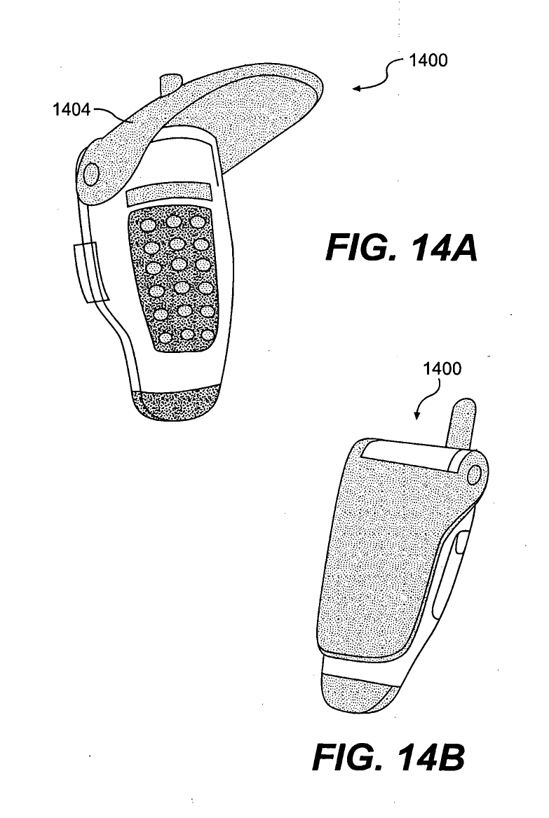

In another embodiment, the toy radio phone 1400 (FIGS. 14A and 14B) includes a cover 1404 that is flipped open to reveal the phone. The toy radio phone 1400 is generally bigger than conventional cell phones because of the power source, which is usually a set of AA batteries.

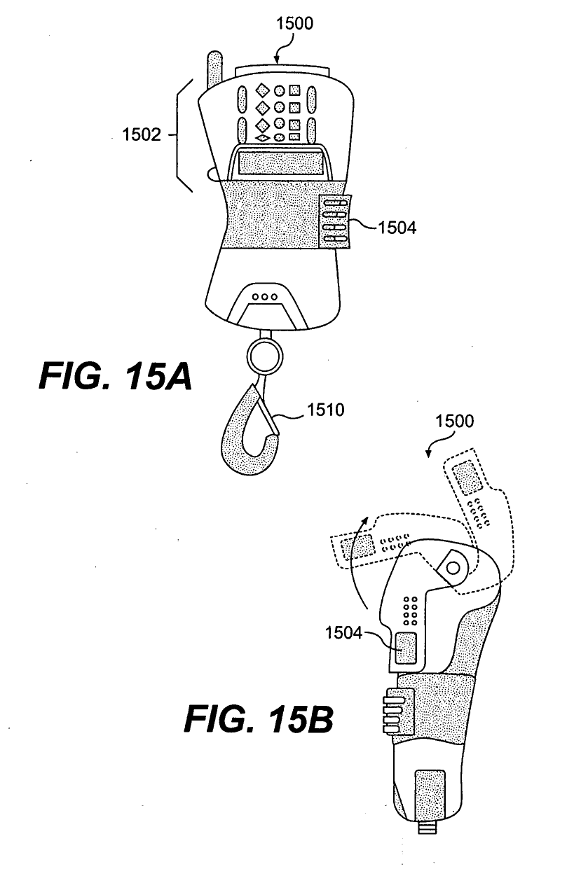

In another embodiment, the toy radio phone 1500 (FIGS. 15A and 15B) has a see-through cover 1502 that may be flipped open. The toy radio phone has an on/off button or slider 1504 that may be pushed or slid up and down. A belt hook or neck hook ring 1508 is also available.

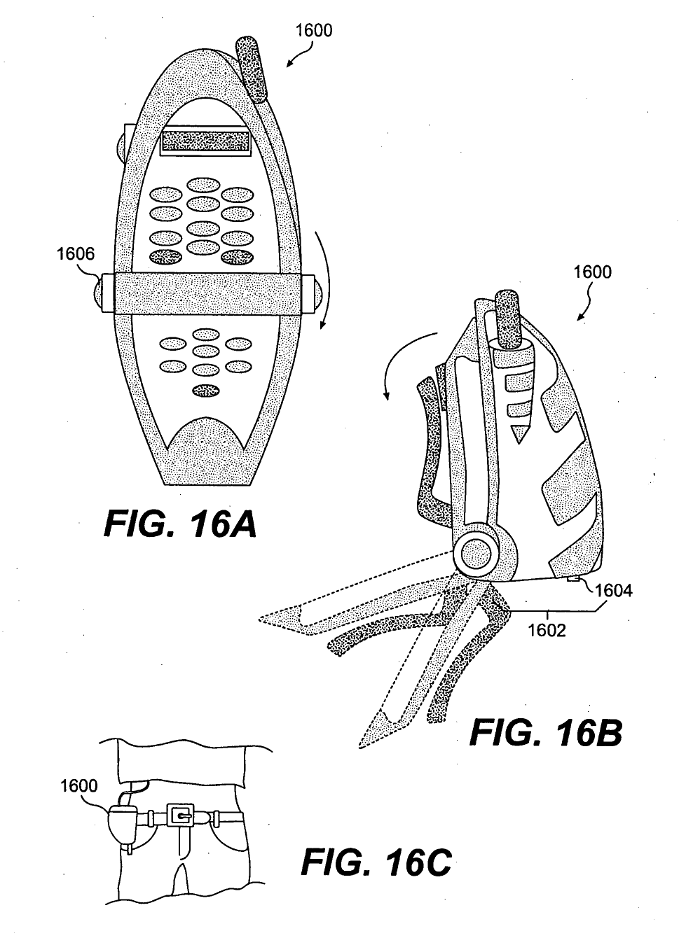

In yet another embodiment, the toy radio phone 1600 (FIGS. 16A through 16C) does not automatically shut-off when the phone is flipped closed. This toy radio phone 1600 thus may be worn with an earbud or a headset when worn with a belt (FIG. 16C). It also has a wider base 1602 to facilitate having this toy radio phone stand, for example, on top of a table. It is toggled on and off by an on/off button 1606. External devices may be plugged into the jack 1604.

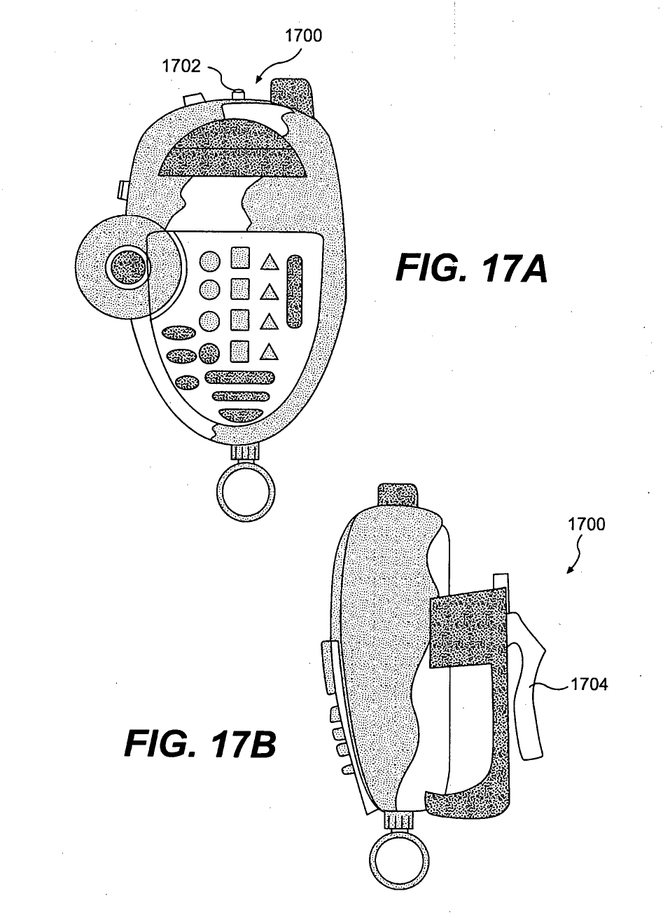

In still another embodiment, the toy radio phone 1700 (FIGS. 17A and 17B) has no internal input (e.g. microphone) or output (e.g. speaker) device. Inputs and outputs are through external devices, such as headsets that are capable of both input and output. This headset is plugged into the jack 1702. The toy radio phone 1700 may be worn on a belt using a belt clip 1704.

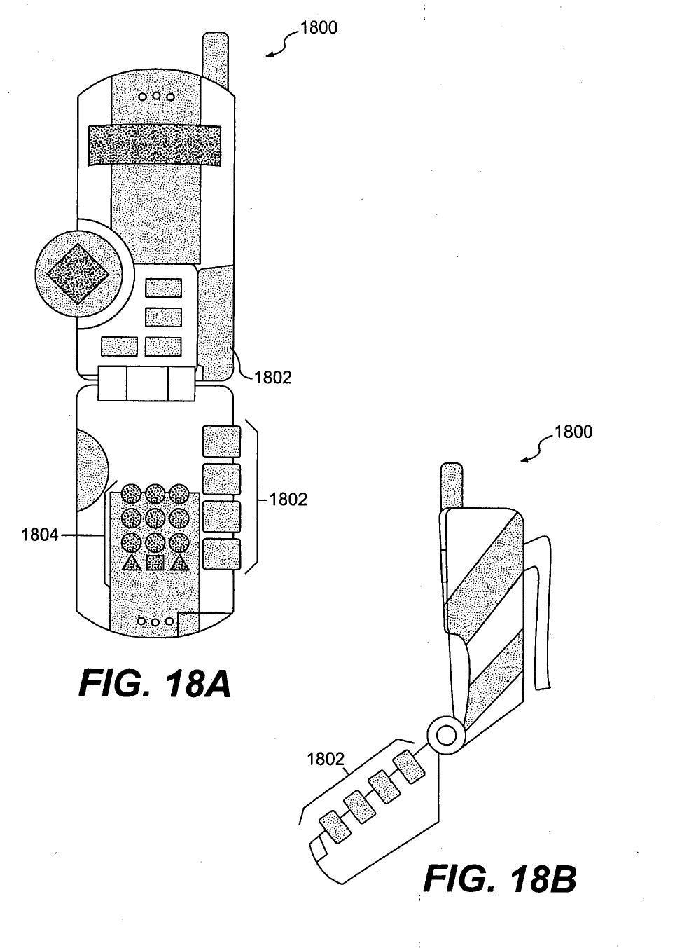

In another embodiment, the toy radio phone 1800 (FIGS. 18A and 18B) has feature buttons, such as “Program,” “Send,” “Answer,” etc. distributed on the top and bottom portion of the toy radio phone 1800. It also includes a keypad 1804.

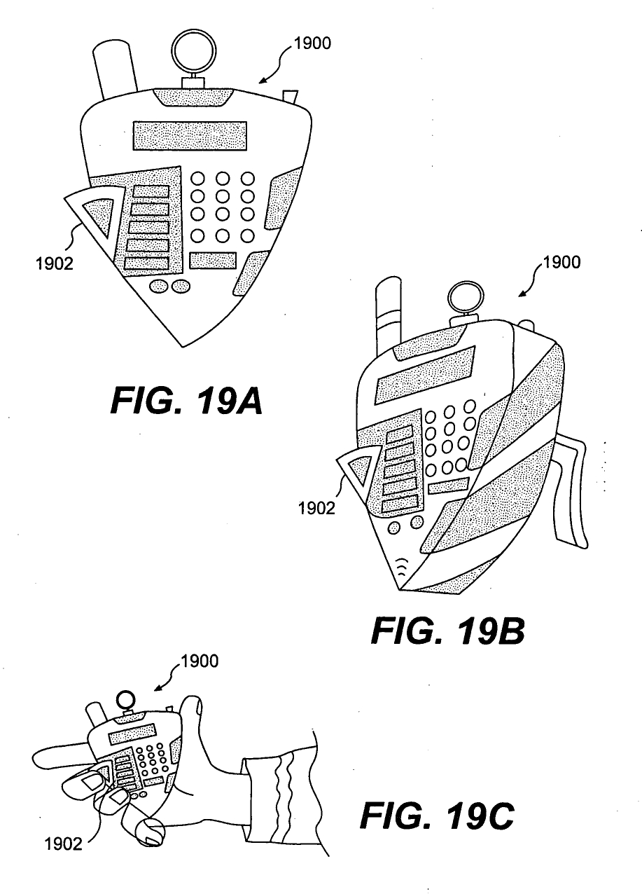

In yet another embodiment, the toy radio phone 1900 (FIGS. 19A through 19C) is designed to be held snugly by the child's hand (FIG. 19C). The on/off button 1902 thus is easily triggered by the child's middle finger (FIG. 19C).

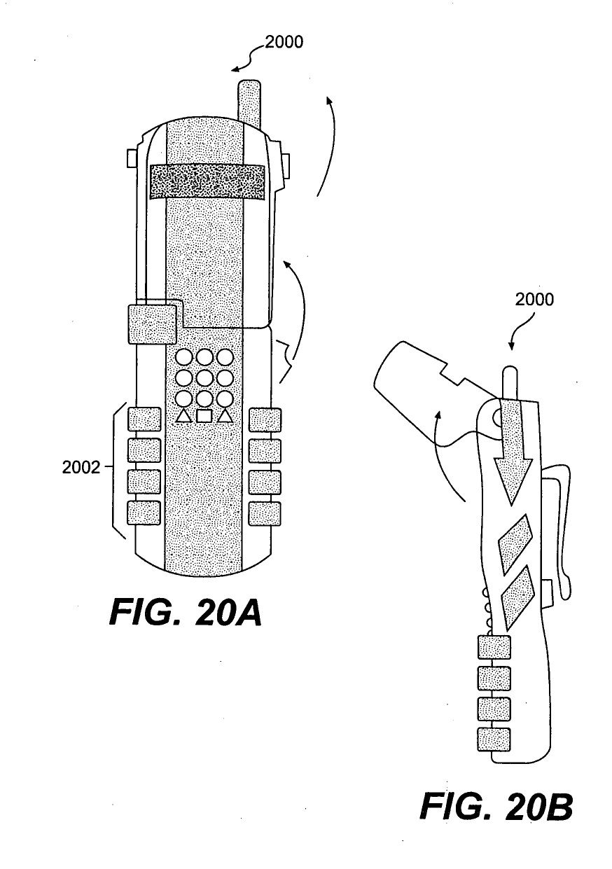

In yet another embodiment, the toy radio phone 2000 (FIGS. 20A and 20B) has feature buttons 2002 on both sides of the toy radio phone. An on/off slider 2004 is used to turn the unit on or off.

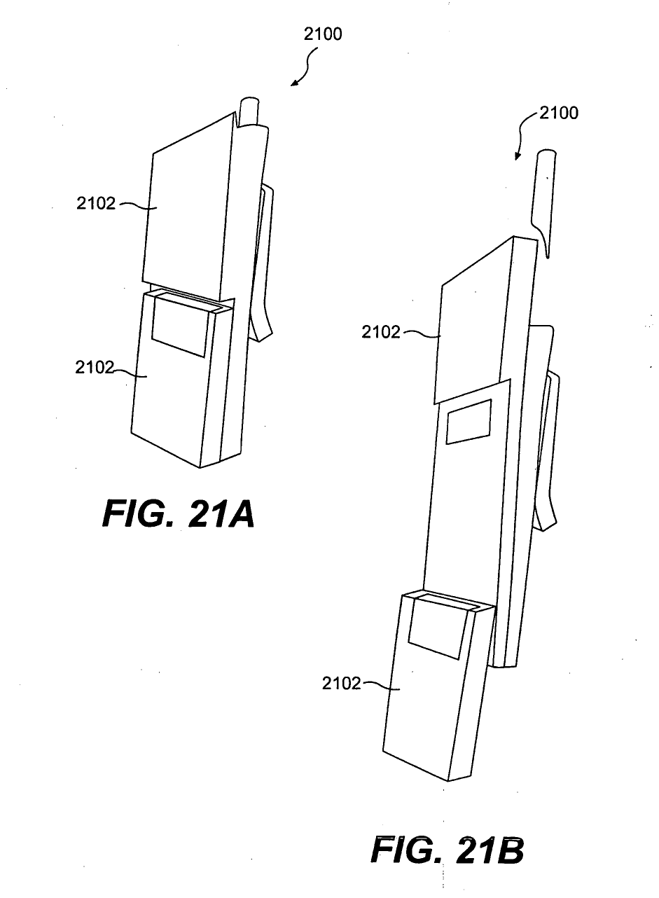

In another embodiment, the replaceable covers 2102 (FIGS. 21A and 21B) may be slid up and down. These covers 2002 may also be replaced with ones suiting the child's taste. As shown by our discussion above, the case or housing of the toy radio phone may be designed in many ways to support various aesthetic and utilitarian designs.

The present invention has been described above in terms of a now-preferred embodiment so that an understanding of the invention can be conveyed. There are, however, many configurations for toy radio phones, not specifically described herein but to which the present invention is still applicable. The foregoing illustrates preferred embodiments of the invention by way of example, not by way of limitation.

For example, the operations and features to control the toy radio phone may be varied, such as a calling child may directly access and leave a voice-mail message, i.e. the child user may leave a voice-mail message without having the opportunity to speak to the called party. This may be implemented by having a calling signal include or encoded with a “direct message” code type. The operations discussed above, including the sequence, may also be changed. The design of the toy radio phone housings may also be changed. Other features, such as beeping when another call is coming through (three-way calling), accessing additional ringing and alert sounds or additional features via an expansion cartridge that is plugged into the toy radio phone, text-to-speech synthesizing to change transmitted text to audio messages, accessing an external voice mail stored in another toy radio phone by calling that toy radio phone and typing in a password, game-playing features, and the like, may be included in the above-discussed embodiments of toy radio phones. A person skilled in this field will recognize that such variations may exist without departing from the principles of the invention. The present invention should therefore not be seen as limited to the particular embodiments described herein, but rather should be understood to have wide applicability with respect to toy radio phones. All modifications, variations, or equivalent arrangements and implementations that are within the scope of the attached claims should therefore be considered within the scope of the invention.

1. A method of receiving a radio message by a receiving toy radio phone programmed with one or more identity phone numbers identifying the receiving toy radio phone, said message containing audio and/or textual data, and said method comprising the steps of:
receiving a direct point-to-point encoded radio calling signal containing at least one toy radio phone number or a portion thereof, said each toy radio phone number or a portion thereof, contained in the calling signal, indicating an intended receiving toy radio phone or phones;
decoding said received calling signal to determine said intended toy radio phone or phones; and
determining whether said receiving toy radio phone is one of said intended toy radio phones.

2. The method of claim 1, further comprising the step of:
enabling a user to speak and listen at the same time using said receiving toy radio phone.

3. The method of claim 1, further comprising the step of:
sending a radio acknowledgement signal by said receiving toy radio phone.

4. The method of claim 1, further comprising the step of:
receiving said radio message by said receiving toy radio phone.

5. The method of claim 4, further comprising the step of:
storing said radio message into a memory of said receiving toy radio phone.

6. The method of claim 4, further comprising the step of:
displaying said received message on a screen.

7. The method of claim 4, further comprising the step of:
producing in audio said received message

8. The method of claim 1, further comprising the step of:
generating an alert when said receiving toy radio phone is determined to be one of said intended toy radio phones.

9. The method of claim 1:
wherein said calling signal is encoded into a radio frequency transmission by using dual-tone multifrequency (DTMF) tone codes.

10. The method of claim 1:
wherein said calling signal is encoded into a radio frequency transmission by using amplitude modulation (AM).

11. The method of claim 1:
wherein said calling signal is encoded into a radio frequency transmission by using frequency modulation (FM).

12. The method of claim 1:
wherein said calling signal is encoded into a radio frequency transmission by using phase modulation (PM).

13. The method of claim 1:
wherein said calling signal is encoded into a radio frequency transmission by using single sideband (SSB).

14. The method of claim 1:
wherein said calling signal is encoded into a radio frequency transmission by using double sideband (DSB).

15. The method of claim 1, further comprising the step of:
blocking reception of the message.

16. A method of storing and later sending an audio and/or textual message by a calling toy radio phone, said method comprising the steps of:
providing said message to the calling toy radio phone;
storing said message into a memory of said calling toy radio phone;
providing to said calling toy radio phone one or more phone numbers or a portion thereof identifying an intended receiving toy radio phone or phones;
and
sending said message to the intended receiving toy radio phone or phones.

17. The method of claim 16:
wherein said sending step is based on a criterion or set of criteria.

18. The method of claim 16, further comprising the step of:
receiving said sent message by said one of the intended receiving phones.

19. The method of claim 18, further comprising the step of:
storing said received message into the memory of said one of the intended receiving toy radio phones.

20. The method of claim 18, further comprising the step of:
displaying said received message on a screen.

21. The method of claim 18, further comprising the step of:
producing in audio said received message.

22. The method of claim 16:
wherein said sending step includes sending said one or more phone numbers or a portion thereof identifying an intended receiving toy radio phone or phones, provided to said calling phone.

23. The method of claim 16:
wherein the sending step uses suppressed carrier modulation (SC).

24. The method of claim 16:
wherein the sending step uses pulse position modulation (PPM).

25. The method of claim 16:
wherein the sending step uses pulse width modulation (PWM).

26. The method of claim 16:
wherein the sending step uses frequency shift keying.(FSK).

27. The method of claim 16, further comprising the step of:
sending one or more handshaking signals.

28. A device for use with a toy radio phone, said device comprising:
a processor;
an operating program controlling and instructing the processor to cause the toy radio phone to receive a direct point-to-point encoded radio calling signal containing at least one toy radio phone number or a portion thereof, said each toy radio phone number or a portion thereof, contained in the calling signal, indicating an intended receiving toy radio phone or phones;
decode said received calling signal to determine said intended toy radio phone or phones; and
determine whether said toy radio phone is one of said intended toy radio phones;
and
a memory storing said operating program.

29. The device of claim 28:
wherein said operating program further controlling and instructing said processor to enable a user to speak and listen at the same time.

30. The device of claim 28:
wherein said operating program further controlling and instructing said processor to send a radio acknowledgement signal.

31. The device of claim 28:
wherein said operating program further controlling and instructing said processor to receive a message containing audio and/or textual data.

32. The device of claim 31:
wherein said operating program further controlling and instructing said processor to store said message into a memory of said toy radio phone.

33. The device of claim 31:
wherein said operating program further controlling and instructing said processor to produce in audio said received message.

34. The device of claim 28:
wherein said operating program further controlling and instructing said processor to generate an alert when said toy radio phone is determined to be one of said intended toy radio phones.

35. The device of claim 28:
wherein said calling signal is encoded into a radio frequency transmission by using suppressed carrier modulation (SC).

36. The device of claim 28:
wherein said calling signal is encoded into a radio frequency transmission by using pulse position modulation (PPM).

37. The device of claim 28:
wherein said calling signal is encoded into a radio frequency transmission by using pulse width modulation (PWM).

38. The device of claim 28:
wherein said calling signal is encoded into a radio frequency transmission by using frequency shift keying (FSK).

39. The device of claim 28, further comprising:
a screen display interfacing with said processor.

40. The device of claim 28, further comprising:
a DTMF modulator and/or demodulator interfacing with said processor.

41. A device for use with a toy radio phone, said device comprising:
a processor;
an operating program controlling and instructing the processor to cause the toy radio phone to provide an audio and/or textual message to said toy radio phone;
store said message into a memory of said toy radio phone;
provide to said toy radio phone one or more phone numbers or a portion thereof identifying an intended receiving toy radio phone or phones; and
send said message to the intended receiving toy radio phone or phones;
and
a memory storing said operating program.

42. The device of claim 41:
wherein said sending step is based on a criterion or set of criteria.

43. The device of claim 41:
wherein said operating program further controlling and instructing said processor to receive said sent message by said one of the intended receiving phones.

44. The device of claim 41:
wherein said operating program further controlling and instructing said processor to store said received message into the memory of said one of the intended receiving toy radio phones.

45. The device of claim 43:
wherein said operating program further controlling and instructing said processor to display said received message on a screen.

46. The device of claim 41:
wherein said sending step includes sending said one or more phone numbers or a portion thereof identifying an intended receiving toy radio phone or phones, provided to said calling phone.

47. The device of claim 41:
wherein the sending step uses dual-tone multifrequency (DTMF) tone codes.

48. The device of claim 41:
wherein the sending step uses amplitude modulation (AM).

49. The device of claim 41:
wherein the sending step uses frequency modulation (FM).

50. The device of claim 41:
wherein the sending step uses phase modulation (PM).

51. The device of claim 41:
wherein the sending step uses single sideband modulation(SSB).

52. The device of claim 41:
wherein the sending step uses double sideband modulation(DSB)

53. The device of claim 41:
wherein said operating program further controlling and instructing said processor to send one or more handshaking signals.

54. The device of claim 41, further comprising:
an acoustic transducer interfacing with said processor.

55. A toy radio phone device comprising:
an antenna;
a radio frequency receiver circuit interfacing with said antenna;
a radio frequency transmitter circuit interfacing with said antenna;
a microcontroller, including a processor, a read-only memory, and an operating program stored in said read-only-memory to perform a method; said method comprising the steps of:
receiving a direct point-to-point encoded radio calling signal containing at least one toy radio phone number or a portion thereof, said each toy radio phone number or a portion thereof, contained in the calling signal, indicating an intended receiving toy radio phone or phones;
decoding said received calling signal to determine said intended toy radio phone or phones;
and
determining if said receiving toy radio phone is one of said intended toy radio phones;
and
a housing to house said antenna, said receiver circuit, said transmitter circuit, and said microcontroller.

56. A toy radio phone device of claim 55, further comprising:
a duplexer housed in said housing.

57. A method of communicating between a calling radio phone and a receiving radio phone, said method comprising the steps of:
providing to the calling toy radio phone one or more phone numbers or a portion thereof portion thereof identifying the receiving toy radio phone;
providing an audio and/or textual message to the calling toy radio phone;
storing the message into a memory of the calling toy radio phone;
receiving a direct point-to-point radio calling signal by the receiving toy radio phone from the calling toy radio phone, the calling signal containing at least one toy radio phone number or a portion thereof identifying the receiving toy radio phone;
sending by said receiving toy radio phone one or more signals to the calling toy radio phone;
and
sending, by the calling toy radio phone, the message to the receiving toy radio phone.

58. A method of claim 571, further comprising the steps of:
storing the message into a memory by the receiving toy radio phone.
